(19) United States
(12) Patent Application Publication
(10) Pub. No.: US 2026/0135799 A1
(43) Pub. Date: May 14, 2026

(54) ELECTRONIC DEVICE AND METHOD FOR TRANSMITTING DATA OVER MULTIPLE NETWORK PATHS

(71) Applicant: MEDIATEK INC., Hsinchu City (TW)

(72) Inventors: Chien-Yi WANG, Hsinchu City (TW); Hao-Cheng WANG, Hsinchu City (TW)

(21) Appl. No.: 19/299,545

(22) Filed: Aug. 14, 2025

Related U.S. Application Data
(60) Provisional application No. 63/719,155, filed on Nov. 12, 2024.

(51) Int. Cl. H04L 45/24; H04L 43/0829; H04L 43/087

(52) U.S. Cl. CPC H04L 45/24; H04L 43/0829; H04L 43/087

(57) ABSTRACT

An electronic device operated as a first user equipment (UE) is provided. The electronic device includes a transceiver and a processing circuit. The transceiver is configured to transmit the first packet to the second UE through the first network path and to transmit the second packet to the second UE through the second network path. The processing circuit is configured to determine the first codec rate of the first network path based on the first network condition of the first network path and to determine the second codec rate of the second network path based on the second network condition of the second network path. The processing circuit is further configured to determine that the first codec rate is higher than the second codec rate, in response to a determination that the first network condition is better than the second network condition.

### CROSS REFERENCE TO RELATED APPLICATIONS

This application claims priority of U.S. Provisional Application Ser. No. 63/719,155, filed on 2024 Nov. 12, the entirety of which are incorporated by reference herein.

### TECHNICAL FIELD

The present invention relates to communication method, and, in particular, it relates to transmitting packets through different paths using different configurations.

### BACKGROUND

The transmission of media data is sensitive to network conditions, which can vary significantly. When the network condition is poor, the quality of the communication will be degraded, and the user experience is negatively impacted. The mechanism of packet duplication over multiple paths is introduced to address this issue. The duplicated packets can facilitate the stability and robustness of the packet transmission. However, the current mechanism doesn't take the diversity of network conditions between different paths into consideration. For example, the same configuration is applied to all paths. The selection of the configuration may be determined based on, for example, hardware capability of the device, without taking the network condition into consideration. Thus, the existing mechanism for transmitting packets over multiple paths is not satisfactory in all respects and doesn't reach its full potential.

Methods for transmitting data over multiple paths is required to solve the aforementioned problem.

### BRIEF SUMMARY

An embodiment of the present invention provides an electronic device, operated as a first user equipment (UE). The electronic device comprises a transceiver and a processing circuit. The transceiver is configured to transmit the first packet to the second UE through the first network path and to transmit the second packet to the second UE through the second network path. The processing circuit is configured to determine the first codec rate of the first network path based on the first network condition of the first network path. The processing circuit is further configured to determine the second codec rate of the second network path based on the second network condition of the second network path. The processing circuit is further configured to determine that the first codec rate is higher than the second codec rate, in response to a determination that the first network condition is better than the second network condition.

An embodiment of the present invention provides a method for transmitting data over multiple network paths. The method comprises using a transceiver of a first user equipment (UE) to transmit the first packet to the second UE through the first network path. The method further comprises using the transceiver of the first UE to transmit the second packet to the second UE through the second network path. The method further comprises using a processing circuit of the first UE to determine the first codec rate of the first network path based on the first network condition of the first network path. The method further comprises using the processing circuit of the first UE to determine the second codec rate of the second network path based on the second network condition of the second network path. The method further comprises using the processing circuit of the first UE to determine that the first codec rate is higher than the second codec rate, in response to a determination that the first network condition of the first network path is better than the second network condition of the second network path.

### BRIEF DESCRIPTION OF THE DRAWINGS

The present disclosure can be more fully understood by reading the subsequent detailed description and examples with references made to the accompanying drawings, wherein:

FIG. 1 is a block diagram of the communication system in accordance with the embodiments of the present disclosure;

FIG. 2 is a block diagram of the electronic device in accordance with the embodiments of the present disclosure;

FIG. 3 is an illustration diagram in accordance with embodiments of the present disclosure;

FIG. 4 is an illustration diagram in accordance with embodiments of the present disclosure;

FIG. 5A is an illustration diagram in accordance with embodiments of the present disclosure;

FIGS. 5B and 5C are illustration diagrams showing the robust transfer in accordance with embodiments of the present disclosure;

FIG. 6 is an illustration diagram in accordance with embodiments of the present disclosure;

FIG. 7 is an illustration diagram in accordance with embodiments of the present disclosure; and

FIG. 8 is a flow diagram of a method 80 for transmitting data over multiple network paths in accordance with the embodiments of the present disclosure.

### DETAILED DESCRIPTION

The following description is made for the purpose of illustrating the general principles of the disclosure and should not be taken in a limiting sense. The scope of the disclosure is best determined by reference to the appended claims.

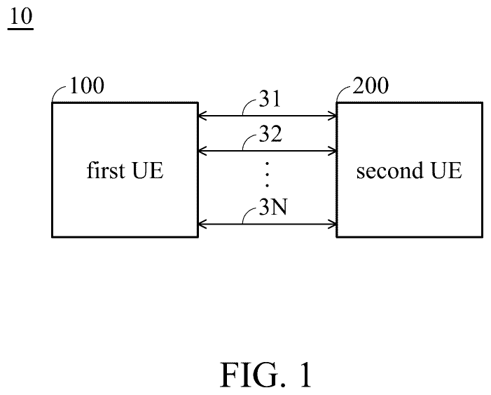

FIG. 1 is a block diagram of the communication system 10 in accordance with the embodiments of the present disclosure. The communication system 10 comprises an electronic device 100 and an electronic device 200. The electronic device 100 is operated as a UE and may also be referred to as the first UE 100. The electronic device 200 is operated as a UE and may also be referred to as the second UE 200. The first UE 100 is configured to communicate with the second UE 200 through network paths 31˜3N. N may be any natural number greater than 1. Specifically, the first UE 100 is configured to transmit the first packet to the second UE 200 through the first network path 31. The first UE 100 is further configured to transmit the second packet to the second UE 200 through the second network path 32. The network paths 31˜3N are paths in the network rather than the paths in the physical space. For example, the first network path 31 and the second network path 32 may go through different routers, access points, base stations and/or gateways. All of the network paths 31˜3N are maintained during the communication between the first UE 100 and the second UE 200. In some embodiments, the first packet is transmitted through the first path 31 at the same time that the second packet is transmitted through the second path 32.

In some embodiments, one of the first packet and the second packet is transmitted using long term evolution (LTE) technology (e.g. fourth, fifth, or sixth generation mobile communication technology (4G, 5G, or 6G)), and the other of the first packet and the second packet is transmitted using non-LTE technology (e.g. Wi-Fi). In other words, one of the first network path 31 and the second network path 32 applies LTE technology and the other of the first packet and the second packet applies non-LTE technology. In other embodiments, the first packet and the second packet may be transmitted using the same technology. In some embodiments, the data in the first packet and the second packet is media data, such as voice data, image data, audio data, video data, or a combination thereof.

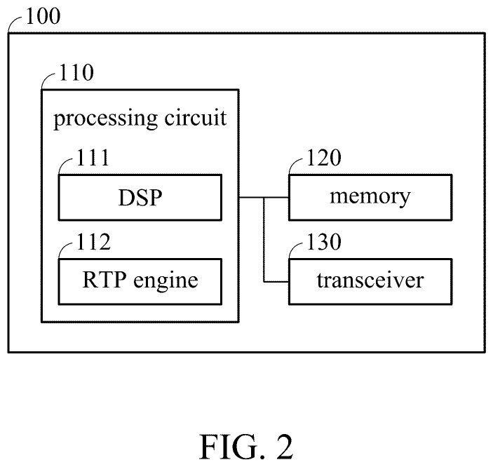

FIG. 2 is a block diagram of the electronic device 100 in accordance with the embodiments of the present disclosure. For example, the electronic device 100 may be a mobile device, a wearable device, a wireless communication device, an Internet of thing (IoT) device, or a computing device. In some embodiments, the electronic device 100 is implemented in a smartphone, a smartwatch, a tablet computer, or a notebook computer. The electronic device 100 comprises a processing circuit 110, a memory 120, and a transceiver 130.

The processing circuit 110 comprises a digital signal processor (DSP) 111 and a real-time protocol (RTP) engine 112. The DSP 111 is configured to receive the voice or image, sample the data, perform the analog-to-digital transformation to the data, slicing the data into multiple frames, and compress the data at different codec rate to generate a packet. The RTP engine 112 is configured to transmit/receive the data in accordance with the real-time protocol. The RTP engine 112 is configured to determine the codec rate. The RTP engine 112 is further configured to perform the encapsulation, add the header to the packet, and decide the network path.

Furthermore, the processing circuit 110 may comprise other elements to control operations of the electronic device 100 and provide the required process ability to perform operating systems, programs, software, modules, applications, and functions of the electronic device 100. In some embodiments, the processing circuit 110, the DSP 111, and the RTP engine 112 may be implemented in the form of hardware with electronic components including transistors, diodes, capacitors, resistors, or inductors. These components are configured and arranged to achieve specific purposes in accordance with the embodiments of the present disclosure. In other words, the processing circuit 110, the DSP 111, and the RTP engine 112 are special-purpose machines specifically configured to perform specific tasks including in accordance with the embodiments of the present disclosure. For example, the processing circuit 110 may further include a processor, a general purpose micro-processor, the special purpose processor, a central processing unit (CPU), an application processor, a graphics processing unit (GPU), an image signal processor (ISP), a controller, and/or related chip set.

The memory 120 stores data and instructions required by the processing circuit 110. The memory 120 may include non-volatile memories, such as read only memory (ROM) and flash memory. The memory 120 may also include volatile memories, such as dynamic random access memory (DRAM) and static random access memory (SRAM). In some embodiments, the memory 120 stores a program, such as the computer-readable instruction. The program can be operated by the processing circuit 110. When the program is operated by the processing circuit 110, the program causes the processing circuit 110 to execute methods in accordance with the embodiments of the present disclosure. The transceiver 130 is configured to transmit/receive data wired or wirelessly. The transceiver 130 may comprise modulator-demodulator (modem) and an antenna. The second UE 200 may comprise components similar to the aforementioned components of the first UE 100.

The following takes the situation that the first UE 100 and the second UE 200 communicates through two network paths (i.e. the first network path 31 and the second network path 32) as example to illustrate embodiments of the present disclosure. In the following examples, the transceiver 130 transmits the first packet to the second UE 200 through the first network path 31 and transmits the second packet to the second UE 200 through the second network path 32. However, it should be understood that the embodiments of the present disclosure can also be applied to the situation that the first UE 100 and the second UE 200 communicates through more than two network paths.

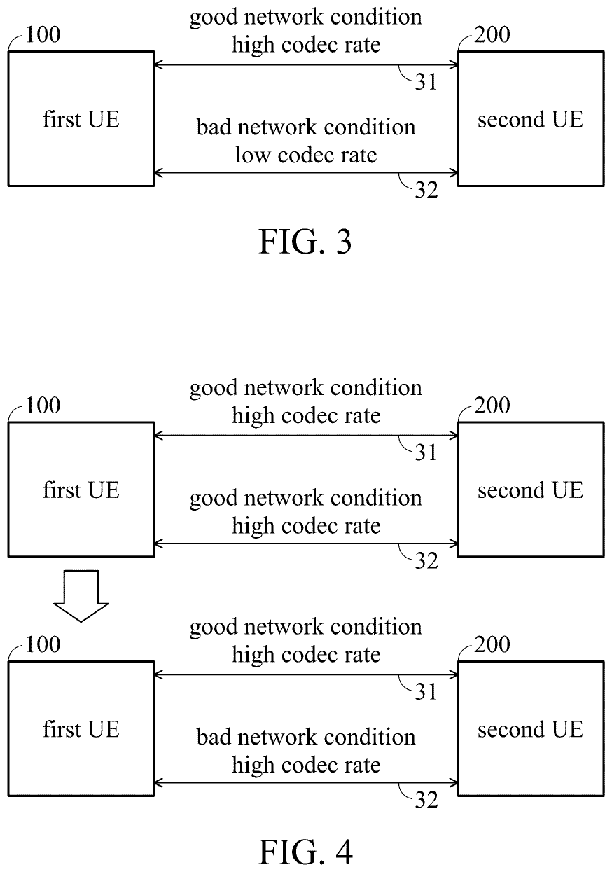

Refer to FIG. 3, FIG. 3 is an illustration diagram in accordance with embodiments of the present disclosure. In this embodiment, the processing circuit 110 (e.g. RTP engine 112) determines the first codec rate of the first network path based on the first network condition of the first network path. The processing circuit 110 (e.g. RTP engine 112) determines the second codec rate of the second network path based on the second network condition of the second network path. When the processing circuit 110 determines that the first network condition of the first network path 31 is better than the second network condition of the second network path 32, the processing circuit 110 (e.g. RTP engine 112) is configured to determine that the first codec rate is higher than the second codec rate. The first codec rate is applied to the first packet and other packets transmitted through the first network path 31, and the second codec rate is applied to the second packet and other packets transmitted through the second network path 32. The DSP 111 is configured to compress media data at the first codec rate to generate the first packet and other packets that will be transmitted on the first network path 31. The DSP 111 is further configured to compress media data at the second codec rate to generate the second packet and other packets that will be transmitted on the second network path 32. The codec rate may be measured in kbits per second (kbits/s).

In some embodiments, the network condition is determined based on packet loss rate, amount of jitter (e.g. number of the presence of jitter), and/or latency of the network path. In other words, the processing circuit 110 determines the first network condition based on packet loss rate, amount of jitter, and/or latency of the first network path 31 and determines the second network condition based on packet loss rate, amount of jitter, and/or latency of the second network path 32. When the packet loss rate of the first network path 31 is lower than the packet loss rate of the second network path 32, the amount of jitter of the first network path 31 is less than the amount of jitter of the second network path 32, and/or the latency of the first network path 31 is shorter than the latency of the second network path 32, the processing circuit 110 determines that the first network condition is better than the second network condition. The latency of a network path may be the duration from the time point that the first UE 100 transmits a packet through the network path to the time point that the second UE 200 receives the packet.

Specifically, the RTP engine 112 measures the network condition of the network paths and determines the codec rate for each of the network paths based on its own network condition. When the network condition is better (i.e. lower packet loss rate, less jitter, and/or shorter latency), the determined codec rate is higher. For example, there may be multiple predetermined intervals of the packet loss rate, the amount of jitter, and/or the latency and codec rates corresponding to these intervals. When the packet loss rate, the amount of jitter, and/or the latency of the network path fall into one of the intervals, the RTP engine 112 may determine that the codec rate of the network path is the codec rate corresponding to the one of the intervals. Furthermore, the RTP engine 112 may periodically determine and update the codec rate. The RTP engine 112 may determine and update the codec rate in real time. The RTP engine 112 may determine and update the codec rate whenever the network condition changed.

Refer to FIG. 4, FIG. 4 is an illustration diagram in accordance with embodiments of the present disclosure. In this embodiment, the processing circuit 110 (e.g. RTP engine 112) determines the first codec rate of the first network path 31 based on the first network condition and the second network condition and determines the second codec rate of the second network path 32 based on the first network condition and the second network condition. The processing circuit 110 (e.g. the RTP engine 112) keeps the first codec rate and the second codec rate unchanged, when the first network condition is unchanged and the second network condition is degraded. Specifically, the processing circuit 110 may determine that the first codec rate and the second codec rate are high codec rate, when the first network condition and the second network condition are good. Then, the first network condition remains good and the second network condition is degraded. In response to a determination that the first network condition remains good and the second network condition is degraded, the processing circuit 110 keeps the first codec rate and the second codec rate at the high codec rate. In some embodiments, the processing circuit 110 determines that the network condition is good, when the packet loss rate of the network path is lower than a threshold, the amount of jitter of the network path is less than a threshold, and/or the latency of the network path is shorter than a threshold. The processing circuit 110 determines that the network condition is degraded, when the packet loss rate, the amount of jitter, and/or the latency of the network path increases.

Keeping the codec rate on all the network paths high, instead of decreasing the codec rate on all the network paths, makes it possible to remain a high data rate, when the network condition of some of the network paths is degraded but the network condition of at least one network path is still good.

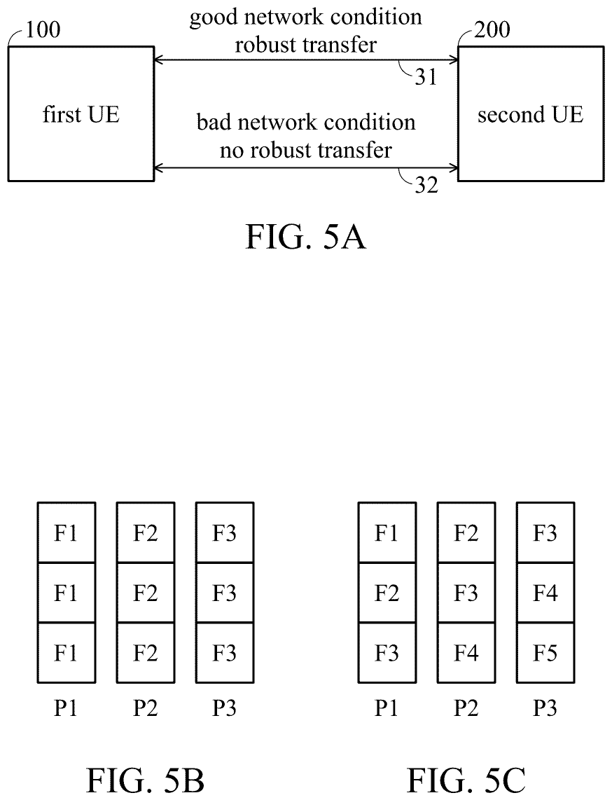

Refer to FIG. 5A, FIG. 5A is an illustration diagram in accordance with embodiments of the present disclosure. In this embodiment, the processing circuit 110 is configured to determine whether to apply a robust transfer to the network path, based on the network condition of the network path. The processing circuit 110 is configured to apply a robust transfer to the first network path 31 and not to apply a robust transfer to the second network path 32, when the first network condition is better than the second network condition. In other words, the processing circuit 110 applies a robust transfer to all the packets transmitted on the first network path 31. The processing circuit 110 doesn't apply a robust transfer to the packets transmitted on the second network path 32. In some embodiments, the robust transfer comprises including multiples of the same frame in one packet. As shown in FIG. 5B, packet P1 comprises multiple frames F1, packet P2 comprises multiple frames F2, and packet P3 comprises multiple frames F3. In some embodiments, the robust transfer comprises transmitting the same frame in multiple packets. As shown in FIG. 5C, packet P1 comprises frames F1, F2, F3, packet P2 comprises frames F2, F3, F4, and packet P3 comprises frames F3, F4, F5. Thus, when the first network condition is better than the second network condition, the transmission scheme shown in FIGS. 5B or 5C is applied to the first network path 31, and the transmission scheme shown in FIGS. 5B or 5C isn't applied to the second network path 32.

In some embodiments, the processing circuit 110 determines to apply a robust transfer to a network path, when the packet loss rate of the network path is lower than a threshold, the amount of jitter of the network path is less than a threshold, and/or the latency of the network path is shorter than a threshold. Thus, the processing circuit 110 may apply a robust transfer to all the network paths or it may not apply the robust transfer to any one of the network path.

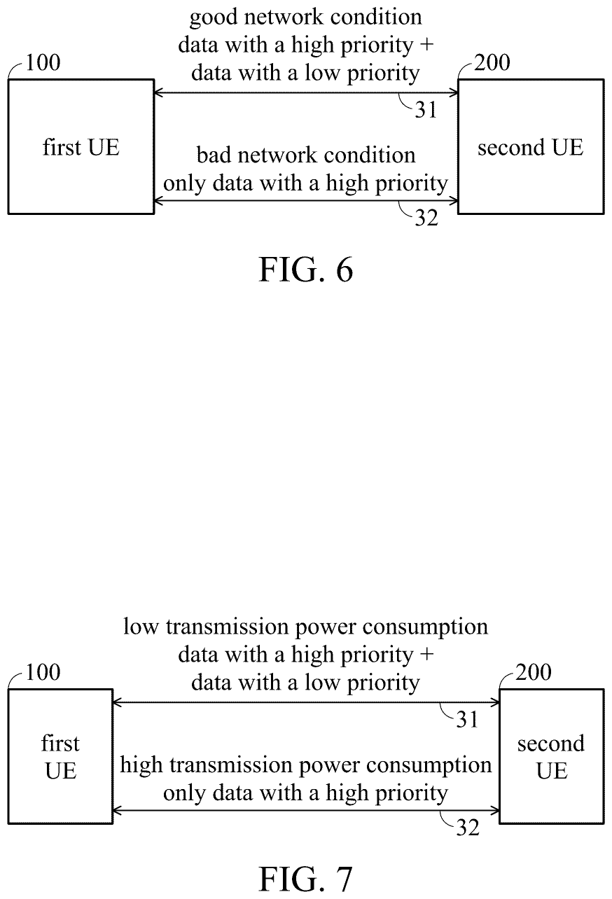

Refer to FIG. 6, FIG. 6 is an illustration diagram in accordance with embodiments of the present disclosure. In this embodiment, the processing circuit 110 is configured to determine whether to transmit the data with a low priority on the network path, based on the network condition of the network path. When the first network condition is better than the second network condition, the processing circuit 110 transmits data with a high priority and data with a low priority on the first network path 31 (e.g. through the transceiver 130). Furthermore, when the first network condition is better than the second network condition, the processing circuit 110 transmits the data with a high priority on the second network path 32 and doesn't transmit the data with a low priority on the second network path 32. In other words, when the first network condition is better than the second network condition, the processing circuit 110 transmits both data with a high priority and data with a low priority on the first network path 31 and only transmits the data with a high priority on the second network path 32. In some embodiments, the data with a high priority indicates the outline or profile of the image or video. The data with a low priority indicates the detail of the image or video. Combining the data with a high priority and low priority, the electronic device 100 can display the high-quality image. However, the electronic device 100 can still display images with low clarity using only the data with a high priority.

In some embodiments, the processing circuit 110 determines to transmit data with a high priority and data with a low priority on a network path, when the packet loss rate of the network path is lower than a threshold, the amount of jitter of the network path is less than a threshold, and/or the latency of the network path is shorter than a threshold. Thus, the processing circuit 110 may determine to transmit data with a high priority and data with a low priority on all the network paths. Alternatively, the processing circuit 110 may determine to transmit only the data with a high priority on all the network paths.

Refer to FIG. 7, FIG. 7 is an illustration diagram in accordance with embodiments of the present disclosure. In this embodiment, the processing circuit 110 is configured to determine whether to transmit the data with a low priority on the network path, based on the transmission power consumption of the network path. When the first transmission power consumption of the first network path 31 is lower than the second transmission power consumption of the second network path 32, the processing circuit 110 transmits data with a high priority and data with a low priority on the first network path 31 (e.g. through the transceiver 130). Furthermore, when the first transmission power consumption of the first network path 31 is lower than the second transmission power consumption of the second network path 32, the processing circuit 110 transmits the data with a high priority on the second network path 32 and doesn't transmit the data with a low priority on the second network path 32. In other words, when the first transmission power consumption is lower than the second transmission power consumption, the processing circuit 110 transmits both data with a high priority and data with a low priority on the first network path 31 and only transmits the data with a high priority on the second network path 32. The data with a high priority and the data with a low priority have been described above and are not described in detail here.

The transmission power consumption of the network path may be the required power to transmit the packet from the first UE 100 through the network path to the second UE 200. In some embodiments, the processing circuit 110 determines to transmit data with a high priority and data with a low priority on a network path, when the transmission power consumption of the network path is lower than a threshold. Thus, the processing circuit 110 may determine to transmit data with a high priority and data with a low priority on all the network paths. Alternatively, the processing circuit 110 may determine to transmit only the data with a high priority on all the network paths.

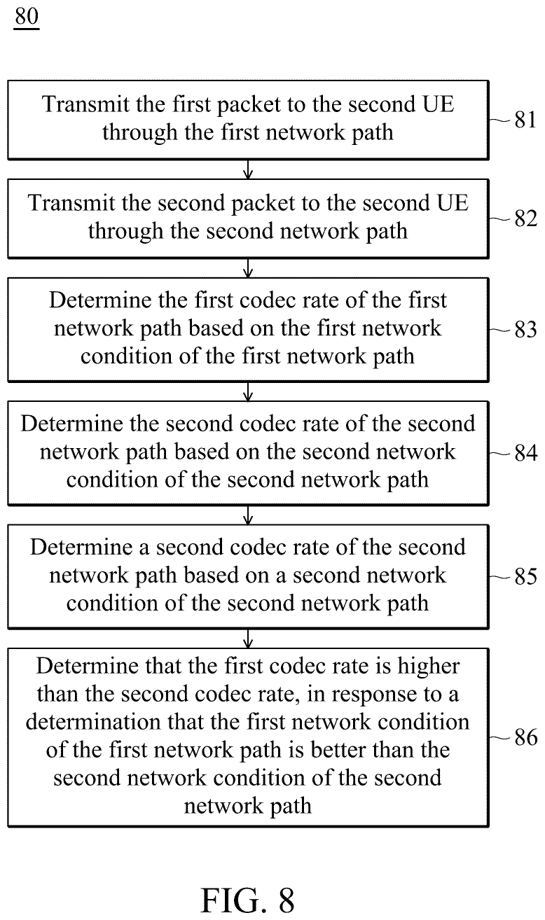

Refer to FIG. 8, FIG. 8 is a flow diagram of a method 80 for transmitting data over multiple network paths in accordance with the embodiments of the present disclosure. Method 80 can be executed by the electronic device 100. In operation 81, the transceiver 130 transmits the first packet to the second UE 200 through the first network path 31. In operation 82, the transceiver 130 transmits the second packet to the second UE 200 through the second network path 32. In operation 83, the processing circuit 110 determines the first codec rate of the first network path 31 based on the first network condition of the first network path 31. In operation 84, the processing circuit 110 determines the second codec rate of the second network path 32 based on the second network condition of the second network path 32. In operation 85, the processing circuit 110 determines the second codec rate of the second network path based on the second network condition of the second network path. In operation 86, the processing circuit 110 determines that the first codec rate is higher than the second codec rate, in response to a determination that the first network condition of the first network path 31 is better than the second network condition of the second network path 32.

In some embodiments, the method 80 further comprises the operation in which the processing circuit 110 determines the first network condition based on packet loss rate, amount of jitter, and/or latency of the first network path 31. The method 80 further comprises the operation in which the processing circuit 110 determines the second network condition based on packet loss rate, amount of jitter, and/or latency of the second network path 32. In some embodiments, the method 80 further comprises the operation in which the processing circuit 110 determines the first network condition is better than the second network condition, in response to a determination that the packet loss rate of the first network path 31 is lower than the packet loss rate of the second network path 32, the amount of jitter of the first network path 31 is less than the amount of jitter in the second network path 32, and/or the latency of the first network path 31 is shorter than the latency of the second network path 32.

In some embodiments, the method 80 further comprises the operation in which the processing circuit keeps the first codec rate and the second codec rate unchanged, in response to a determination that the first network condition is unchanged and the second network condition is degraded. In some embodiments, the method 80 further comprises the operation in which via the processing circuit 110 keeps the first codec rate and the second codec rate at a high codec rate, in response to a determination that the first network condition remains good and the second network condition is degraded.

In some embodiments, the method 80 further comprises the operation in which the processing circuit 110 applies a robust transfer to the first network path and doesn't apply the robust transfer to the second network path, in response to a determination that the first network condition is better than the second network condition. In some embodiments, the robust transfer comprises: including multiples of the same frame in one packet; or transmitting the same frame in multiple packets.

In some embodiments, in response to a determination that the first network condition is better than the second network condition, the method 80 further comprises the following operations: the operation in which the processing circuit 110 transmits data with a high priority and data with a low priority on the first network path 31; the operation in which the processing circuit 110 transmits the data with a high priority on the second network path 32; and the operation in which the processing circuit 110 doesn't transmit the data with a low priority on the second network path 32.

In some embodiments, in response to a determination that the first transmission power consumption of the first network path 31 is lower than the second transmission power consumption of the second network path 32, the method 80 further comprises the following operations: the operation in which the processing circuit 110 transmits data with a high priority and data with a low priority on the first network path 31; the operation in which the processing circuit 110 transmits the data with a high priority on the second network path 32; and the operation in which the processing circuit 110 doesn't transmit the data with a low priority on the second network path 32.

In some embodiments, one of the first packet and the second packet is transmitted using LTE technology, and the other is transmitted using non-LTE technology.

Embodiments of the present disclosure allow the UE to apply different transmission schemes to different network paths. The transmission scheme comprises codec rate, whether to apply a robust transfer or not, and whether to transmit data with a low priority or not. The UE can determine the transmission scheme based on the measured parameters of each of the network paths. For example, the parameter may be the network condition, the packet loss rate, the presence of jitter, the latency, or the transmission power consumption. Thus, the transmission scheme of one network path is adaptive to the fact that the condition of the network path (and the condition of other network paths) and the communication between the UEs can be optimized.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. An electronic device, operated as a first user equipment (UE), comprising:
a transceiver, configured to transmit a first packet to a second UE through a first network path and to transmit a second packet to the second UE through
a second network path; and
a processing circuit, configured to:
determine a first codec rate of the first network path based on a first network condition of the first network path;
determine a second codec rate of the second network path based on a second network condition of the second network path; and
determine that the first codec rate is higher than the second codec rate, in response to a determination that the first network condition is better than the second network condition.

2. The electronic device as claimed in claim 1, wherein the processing circuit is configured to determine the first network condition based on packet loss rate, amount of jitter, and/or latency of the first network path and determine the second network condition based on packet loss rate, amount of jitter, and/or latency of the second network path.

3. The electronic device as claimed in claim 1, wherein the processing circuit is configured to keep the first codec rate and the second codec rate unchanged, in response to a determination that the first network condition is unchanged and the second network condition is degraded.

4. The electronic device as claimed in claim 1, wherein the processing circuit is configured to keep the first codec rate and the second codec rate at a high codec rate, in response to a determination that the first network condition remains good and the second network condition is degraded.

5. The electronic device as claimed in claim 1, wherein the processing circuit is configured to apply a robust transfer to the first network path and not to apply the robust transfer to the second network path, in response to a determination that the first network condition is better than the second network condition.

6. The electronic device as claimed in claim 5, wherein the robust transfer comprises:
including multiples of the same frame in one packet; or
transmitting the same frame in multiple packets.

7. The electronic device as claimed in claim 1, wherein in response to a determination that the first network condition is better than the second network condition, the processing circuit is configured to:
transmit data with a high priority and data with a low priority on the first network path; and
transmit the data with a high priority on the second network path while not transmitting the data with a low priority on the second network path.

8. The electronic device as claimed in claim 1, wherein in response to a determination that a first transmission power consumption of the first network path is lower than a second transmission power consumption of the second network path, the processing circuit is configured to:
transmit data with a high priority and data with a low priority on the first network path; and
transmit the data with a high priority on the second network path while not transmitting the data with a low priority on the second network path.

9. The electronic device as claimed in claim 1, wherein the processing circuit comprises:
a digital signal processor (DSP), configured to compress media data at the first codec rate to generate the first packet and compress the media data at the second codec rate to generate the second packet; and
a real time protocol (RTP) engine, configured to determine the first codec rate and the second codec rate based on the first network condition and the second network condition.

10. The electronic device as claimed in claim 1, wherein one of the first packet and the second packet is transmitted using long term evolution (LTE) technology, and the other of the first packet and the second packet is transmitted using non-LTE technology.

11. A method for transmitting data over multiple network paths, comprising:
transmitting, via a transceiver of a first user equipment (UE), a first packet to a second UE through a first network path;
transmitting, via the transceiver, a second packet to the second UE through a second network path;
determining, via a processing circuit of the first UE, a first codec rate of the first network path based on a first network condition of the first network path;
determining, via the processing circuit, a second codec rate of the second network path based on a second network condition of the second network path; and
determining, via the processing circuit, that the first codec rate is higher than the second codec rate, in response to a determination that a first network condition of the first network path is better than a second network condition of the second network path.

12. The method as claimed in claim 11, further comprising:
determining, via the processing circuit, the first network condition based on packet loss rate, amount of jitter, and/or latency of the first network path; and
determining, via the processing circuit, the second network condition based on packet loss rate, amount of jitter, and/or latency of the second network path.

13. The method as claimed in claim 12, further comprising:
determining, via the processing circuit, the first network condition is better than the second network condition, in response to a determination that packet loss rate of the first network path is lower than packet loss rate of the second network path, amount of jitter of the first network path is less than amount of jitter of the second network path, and/or latency of the first network path is shorter than latency of the second network path.

14. The method as claimed in claim 11, further comprising:
keeping, via the processing circuit, the first codec rate and the second codec rate unchanged, in response to a determination that the first network condition is unchanged and the second network condition is degraded.

15. The method as claimed in claim 11, further comprising:
keeping, via the processing circuit, the first codec rate and the second codec rate at a high codec rate, in response to a determination that the first network condition remains good and the second network condition is degraded.

16. The method as claimed in claim 11, further comprising:
applying, via the processing circuit, robust transfer to the first network path while not applying the robust transfer to the second network path, in response to a determination that the first network condition is better than the second network condition.

17. The method as claimed in claim 16, wherein the robust transfer comprises:
including multiples of the same frame in one packet; or transmitting the same frame in multiple packets.

18. The method as claimed in claim 11, wherein in response to a determination that the first network condition is better than the second network condition, the method further comprises:
transmitting, via the processing circuit, data with a high priority and data with a low priority on the first network path;
transmitting, via the processing circuit, the data with a high priority on the second network path; and
not transmitting the data with a low priority on the second network path.

19. The method as claimed in claim 11, wherein in response to a determination that a first transmission power consumption of the first network path is lower than a second transmission power consumption of the second network path, the method further comprises:
transmitting, via the processing circuit, data with a high priority and data with a low priority on the first network path;
transmitting, via the processing circuit, the data with a high priority on the second network path; and
not transmitting the data with a low priority on the second network path.

20. The method as claimed in claim 11, wherein one of the first packet and the second packet is transmitted using long term evolution (LTE) technology, and the other of the first packet and the second packet is transmitted using non-LTE technology.
